(19) United States
(12) Patent Application Publication
(10) Pub. No.: US 2015/0310829 A1
(43) Pub. Date: Oct. 29, 2015

(54) ELECTRONIC APPARATUS AND IMAGE PROCESSING METHOD

(71) Applicant: Kabushiki Kaisha Toshiba, Tokyo (JP)

(72) Inventor: Eiki Obara, Ome Tokyo (JP)

(21) Appl. No.: 14/687,519

(22) Filed: Apr. 15, 2015

(30) Foreign Application Priority Data
Apr. 24, 2014 (JP) 2014-089869

(51) Int. Cl. G09G 5/10; G09G 5/02

(52) U.S. Cl. CPC G09G 5/10; G09G 5/02

(57) ABSTRACT

According to one embodiment, an electronic apparatus includes a detector and a correction module. The detector receives an image of an object. The image includes a first part and a second part. The first part includes writing by a user. The second part does not include the writing. The detector detects the second part of the image. The correction module corrects luminance of the second part of the image.

### CROSS-REFERENCE TO RELATED APPLICATIONS

This application is based upon and claims the benefit of priority from Japanese Patent Application No. 2014-089869, filed Apr. 24, 2014, the entire contents of which are incorporated herein by reference.

### FIELD

Embodiments described herein relate generally to an electronic apparatus for processing an image and an image processing method applied to the apparatus.

### BACKGROUND

Recently, various electronic apparatuses configured to shoot images such as personal computers, PDAs, mobile phones, smart phones, etc., with a camera and digital cameras have been widespread.

Such electronic apparatuses are sometimes used to shoot an image of content written on an object such as a blackboard or a whiteboard, as well as an image of a person or scenery. The shot image is, for example, stored as personal archives or viewed by a plurality of persons.

The user writes characters, figures, pictures, or the like on the blackboard or whiteboard. The user erases the writing on the blackboard or whiteboard when the written content is no longer necessary, or when the user wants to change the content.

Since the erasing work is performed by wiping off the writing, erasures (erasure residues) may remain on the blackboard. In the case of, for example, the blackboard, the writing with chalk is thinly stretched on the blackboard, causing the blackboard to appear to be in a color (for example, whitish in the case where white chalk is used) obtained by superimposing a color of chalk on an original color (for example, dark green) of the blackboard. Similarly, in the case of the whiteboard, the writing with a pen is thinly stretched on the whiteboard, causing the whiteboard to appear to be in a color (for example, gray in the case where a black pen is used) obtained by superimposing a color of a pen on an original color (white) of the whiteboard.

Thus, if characters, figures, or the like are further written on the blackboard or whiteboard including the erasures, and an image of the blackboard or whiteboard is captured, the image may be hard to view due to the erasures.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an outer appearance of an electronic apparatus according to an embodiment.

FIG. 2 is a block diagram of a system configuration of the electronic apparatus according to the embodiment.

FIG. 3 shows an example of an image of an object in which characters or pictures are written, the image being processed by the electronic apparatus according to the embodiment.

FIG. 4 shows an example where an area in which neither characters nor pictures are written is detected from the image shown in FIG. 3 by the electronic apparatus according to the embodiment.

FIG. 5 is a block diagram of a functional configuration of an image processing program executed by the electronic apparatus according to the embodiment.

FIG. 6 is a figure for illustrating processing by use of a histogram of luminance signal Y of the image shown in FIG. 3 by the electronic apparatus according to the embodiment.

FIG. 7 is a figure for illustrating processing by use of a histogram of color-difference signal U of the image shown in FIG. 3 by the electronic apparatus according to the embodiment.

FIG. 8 is a figure for illustrating processing by use of a histogram of color-difference signal V of the image shown in FIG. 3 by the electronic apparatus according to the embodiment.

FIG. 9 is a flowchart showing an example of procedures of image processing executed by the electronic apparatus according to the embodiment.

### DETAILED DESCRIPTION

Various embodiments will be described hereinafter with reference to the accompanying drawings.

In general, according to one embodiment, an electronic apparatus includes a detector and a correction module. The detector receives an image of an object, the image comprising a first part and a second part, the first part comprising writing by a user, the second part not comprising the writing, and detects the second part of the image. The correction module corrects luminance of the second part of the image.

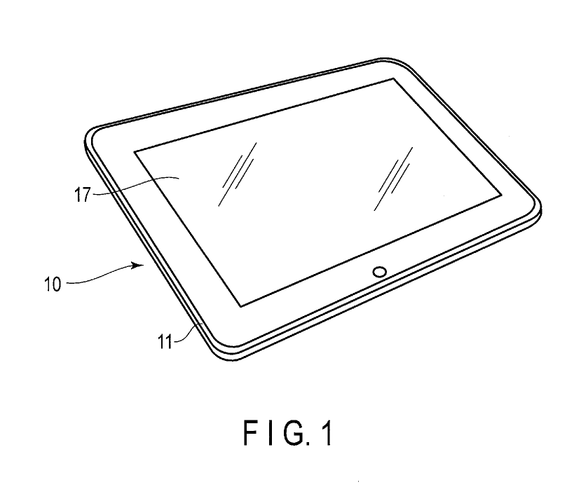

FIG. 1 is a perspective view of an outer appearance of an electronic apparatus according to one embodiment. This electronic apparatus can be realized as a system embedded in various electronic apparatuses such as tablet computers, notebook computers, smart phones, PDAs or digital cameras. Suppose this electronic apparatus is realized as a tablet computer 10. The tablet computer 10 is a portable electronic apparatus also called a tablet or a slate computer, and includes a main body 11 and a touch screen display 17, as shown in FIG. 1. The touch screen display 17 is attached to the upper surface of the main body 11 in piles.

The main body 11 includes a thin box-like housing. A flat panel display and a sensor configured to detect a contact position of a stylus or a finger on a screen of the flat panel display are mounted in the touch screen display 17. The flat panel display may be, for example, a liquid crystal display (LCD). As the sensor, for example, a capacitive touch panel or an electromagnetic induction digitizer can be used.

Further, the main body 11 is provided with a camera module for shooting an image from a side of the lower surface (back surface) of the main body 11.

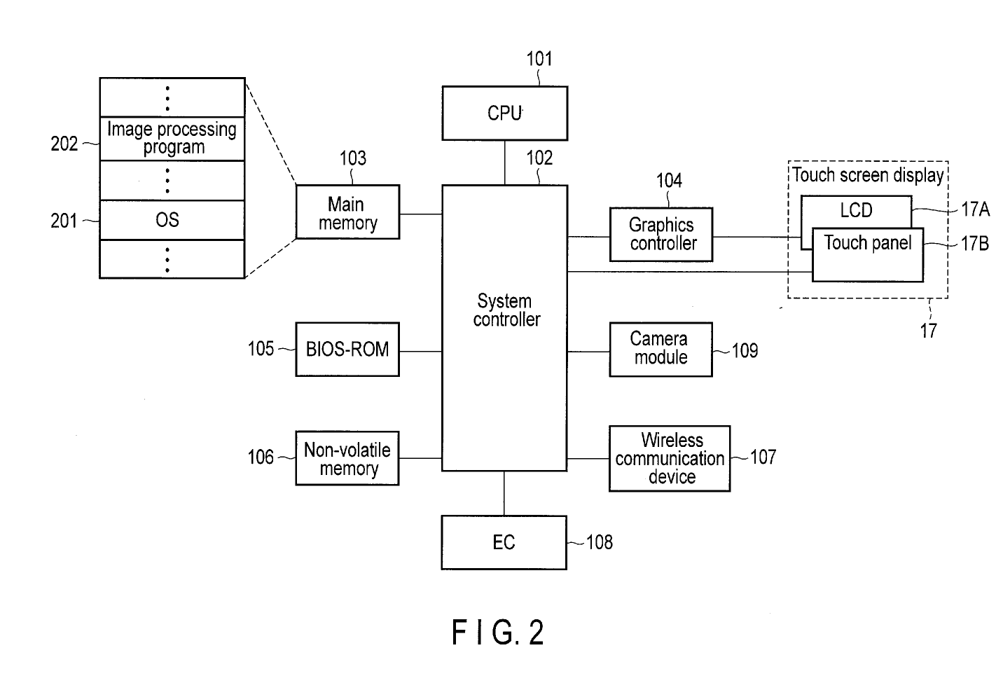

FIG. 2 shows a system configuration of the tablet computer 10.

The tablet computer 10 includes a CPU 101, a system controller 102, a main memory 103, a graphics controller 104, a BIOS-ROM 105, a non-volatile memory 106, a wireless communication device 107, an embedded controller (EC) 108, a camera module 109, etc., as shown in FIG. 2.

The CPU 101 is a processor configured to control operations of various modules in the tablet computer 10. The CPU 101 executes various types of software loaded from the non-volatile memory 106 which is a storage device into the main memory 103. The software includes an operating system (OS) 201 and various application programs. The application programs include an image processing program 202. The image processing program 202 has, for example, a function of reducing the influence of erasures included in an object such as a blackboard or a whiteboard, which are present on an image captured using the camera module 109. Further, the CPU 101 executes a basic input/output system (BIOS) stored in the BIOS-ROM 105. The BIOS is a program for hardware control.

The system controller 102 is a device configured to connect between a local bus of the CPU 101 and various components. The system controller 102 includes a memory controller configured to perform access control on the main memory 103. The system controller 102 also has a function of performing communication with the graphics controller 104 through a serial bus, etc., conforming to the PCI EXPRESS standard.

The graphics controller 104 is a display controller configured to control an LCD 17A used as a display monitor of the tablet computer 10. A display signal generated by the graphics controller 104 is supplied to the LCD 17A. The LCD 17A displays a screen image based on the display signal. A touch panel 17B is arranged on the LCD 17A.

The wireless communication device 107 is a device configured to perform wireless communication such as a wireless LAN or 3G mobile communication. The EC 108 is a single-chip microcomputer including an embedded controller for power management. The EC 108 has a function of powering on or off the tablet computer 10 in accordance with the operation of a power button by the user.

The camera module 109 shoots an image, for example, when the user touches (taps) a button (graphical object) displayed on the screen of the touch screen display 17. The user shoots an image of a blackboard or a whiteboard, using the camera module 109, on which, for example, characters, figures, pictures, etc., are written to store the shot image or to share it with other users.

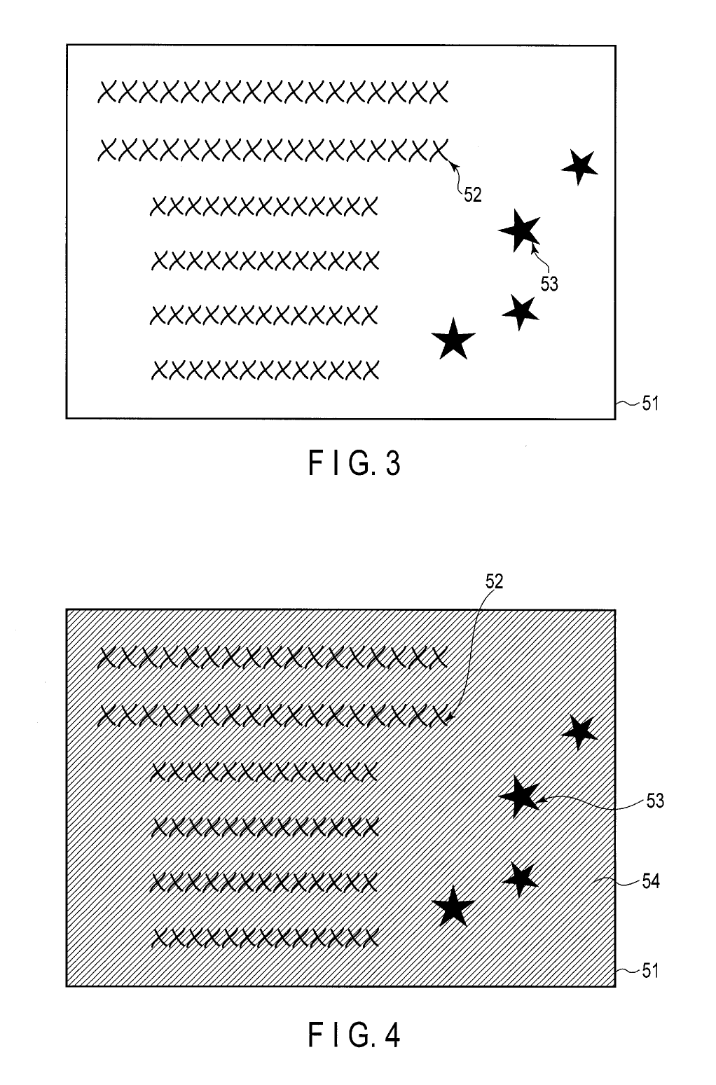

FIG. 3 shows an example of image 51 in which an object such as the blackboard or whiteboard is shot. Characters 52, figures, pictures 53, or the like are written on the blackboard or whiteboard by the user. The user erases the writing on the blackboard or whiteboard when written content is no longer necessary, or when the user wants to change the content. The user erases the writing using, for example, an eraser. Since the erasing work is performed by wiping off the writing, erasures may remain on the blackboard. In the case of, for example, the blackboard, the writing with chalk is thinly stretched on the blackboard, causing the blackboard to appear to be in a color (for example, whitish in the case where white chalk is used) obtained by superimposing a color of chalk on an original color (for example, dark green) of the blackboard. Similarly, in the case of the whiteboard, the writing with a pen is thinly stretched on the whiteboard, causing the whiteboard to appear to be in a color (for example, gray in the case where a black pen is used) obtained by superimposing a color of a pen on an original color (white) of the whiteboard.

Since the work for erasing the writing is performed by wiping off the writing as described above, erasures may remain not only in a portion corresponding to the writing, but also, for example, in an area around the writing and, in addition, on the whole blackboard or whiteboard.

If characters, figures, or the like are further written on the blackboard or whiteboard including the erasures, and an image 51 of the blackboard or whiteboard is shot, the image 51 may be hard to view due to the erasures.

Thus, in the present embodiment, a second area 54 (shaded area in FIG. 4) other than a first area corresponding to writing 52 and 53 by the user is detected from the image 51 in which an object (blackboard, whiteboard, etc.) including the first area is shot, and the luminance of the second area 54 is corrected. Since the second area 54 includes erasures generated by erasing the writing by the user, difficulty in viewing due to the erasures can be reduced by changing the luminance of the second area 54 to the original luminance of the object (luminance of object free from erasures).

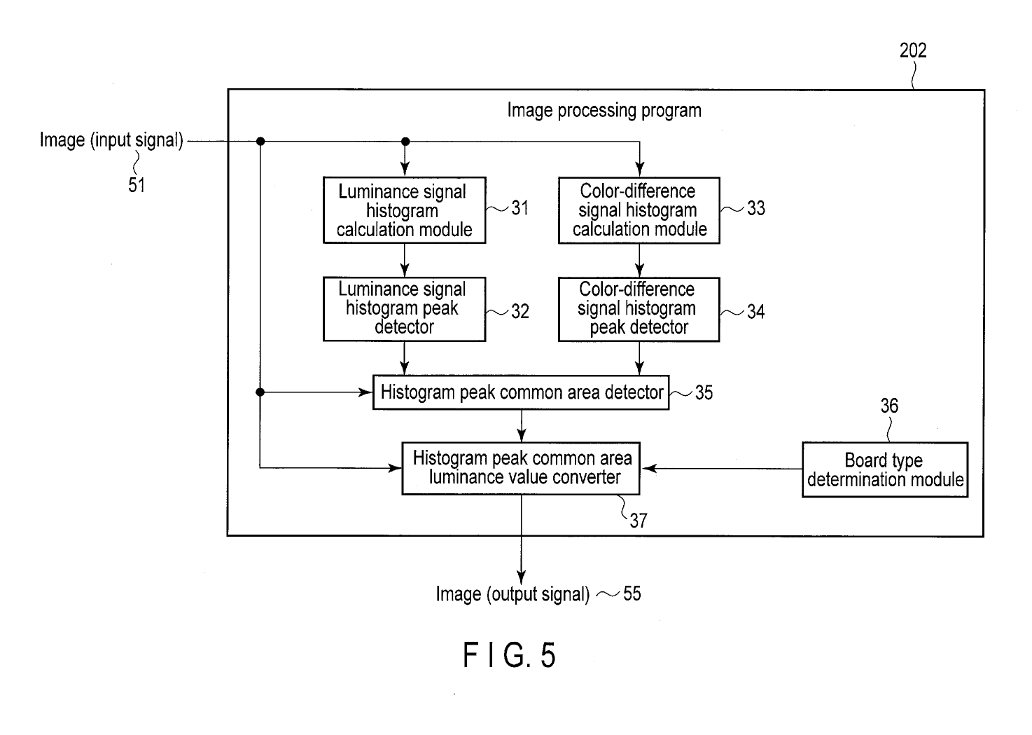

FIG. 5 shows an example of a functional configuration of the image processing program 202 executed by the tablet computer 10. The image processing program 202 has, for example, a function of reducing the influence of erasures included in an object such as the blackboard or whiteboard, which are present on an image shot using the camera module 109. The image processing program 202 includes, for example, a luminance signal histogram calculation module 31, a luminance signal histogram peak detector 32, a color-difference signal histogram calculation module 33, a color-difference signal histogram peak detector 34, a histogram peak common area detector 35, a board type determination module 36 and a histogram peak common area luminance value converter 37.

The luminance signal histogram calculation module 31, the luminance signal histogram peak detector 32, the color-difference signal histogram calculation module 33, the color-difference signal histogram peak detector 34 and the histogram peak common area detector 35 detect the second area 54 other than the first area from the image 51 in which the object including the first area corresponding to the writing 52 and 53 by the user is shot.

Even if the user writes characters or pictures on the whole of the object such as the blackboard or whiteboard, a gap between the characters or pictures, a blank, or the like is in the second area 54, which does not include writing by the user (that is, a background portion in the object). A peak of a histogram of the image 51 is more likely to correspond to a pixel value of a pixel in the second area 54, which does not include the writing by the user. Thus, a peak of a histogram based on YUV signal (or RGB signal) of the image 51 is detected, and a pixel group corresponding to a pixel value within a predetermined range including the peak is detected as the second area 54 in the present embodiment.

First, the luminance signal histogram calculation module 31 and the color-difference signal histogram calculation module 33 calculate the histogram using the image 51 if the image (input signal) 51 of the object including the first area corresponding to the writing 52 and 53 by the user is input.

More specifically, the luminance signal histogram calculation module 31 calculates the histogram of luminance Y using a plurality of luminances (luminance signals) Y corresponding to a plurality of pixels included in the image (input signal) 51. Then, the luminance signal histogram peak detector 32 detects luminance YP having a maximum number (degree) of pixels from the histogram of luminance Y.

Further, the color-difference signal histogram calculation module 33 calculates the histogram of color difference U using a plurality of color differences (color-difference signals) U corresponding to a plurality of pixels included in the image (input signal) 51. Color difference U indicates a difference corresponding to each pixel between luminance Y and a blue component. The color-difference signal histogram peak detector 34 detects color difference UP having a maximum number of pixels from the histogram of color difference U.

Furthermore, the color-difference signal histogram calculation module 33 calculates the histogram of color difference V using a plurality of color differences (color-difference signals) V corresponding to a plurality of pixels included in the image (input signal) 51. Color difference V indicates a difference corresponding to each pixel between luminance Y and a red component. The color-difference signal histogram peak detector 34 detects color difference VP having a maximum number of pixels from the histogram of color difference V.

Next, the histogram peak common area detector 35 detects a first pixel group corresponding to luminance within a predetermined range including luminance YP (for example, luminance from YP−10 to YP+10) from the image 51.

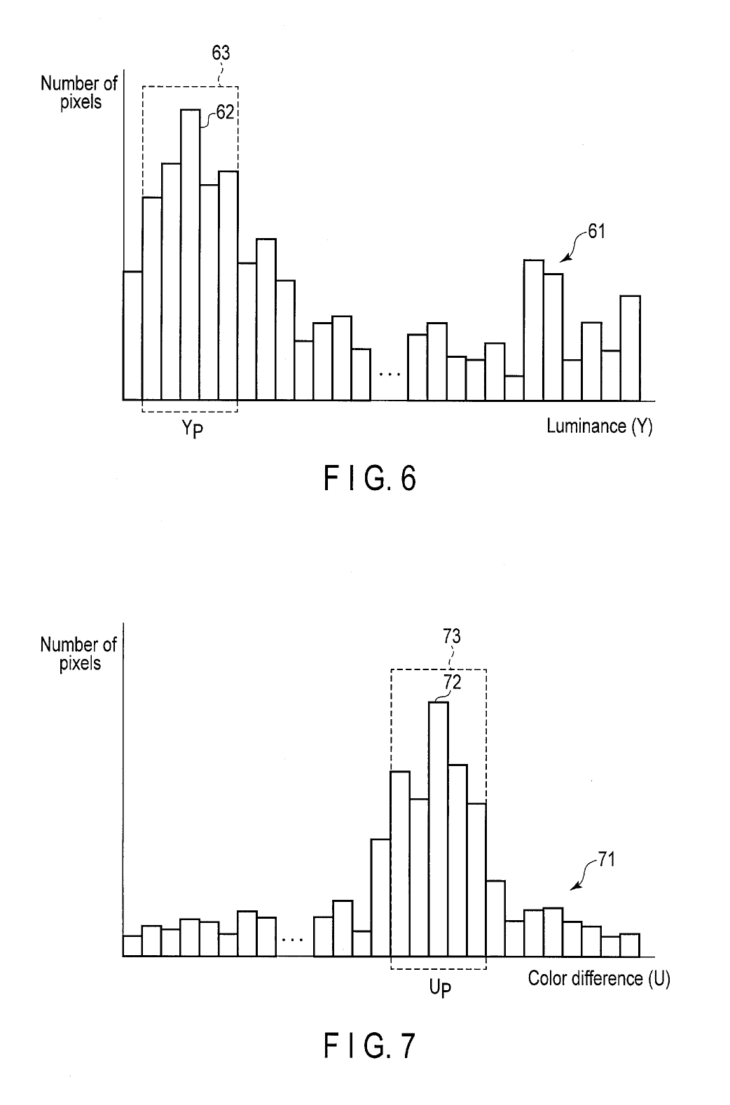

FIG. 6 shows a histogram 61 calculated using a plurality of luminances Y corresponding to a plurality of pixels included in the image 51. Luminance YP 62 having a maximum number of pixels is detected from the histogram 61. Then, luminance 63 within a predetermined range including luminance YP is determined, and the first pixel group, which corresponds to luminance 63 within the predetermined range, in the image 51 is detected.

The histogram peak common area detector 35 detects a second pixel group corresponding to luminance within a predetermined range including color difference UP (for example, luminance from UP−10 to UP+10) from the image 51.

FIG. 7 shows histogram 71 calculated using a plurality of color differences U corresponding to a plurality of pixels included in the image 51. Color difference UP 72 having a maximum number of pixels is detected from the histogram 71. Then, color difference 73 within a predetermined range including the color difference UP 72 is determined, and the second pixel group, which corresponds to the color difference 73 within the predetermined range, in the image 51 is detected.

Further, the histogram peak common area detector 35 detects a third pixel group corresponding to luminance within a predetermined range including color difference VP (for example, luminance from VP−10 to VP+10) from the image 51.

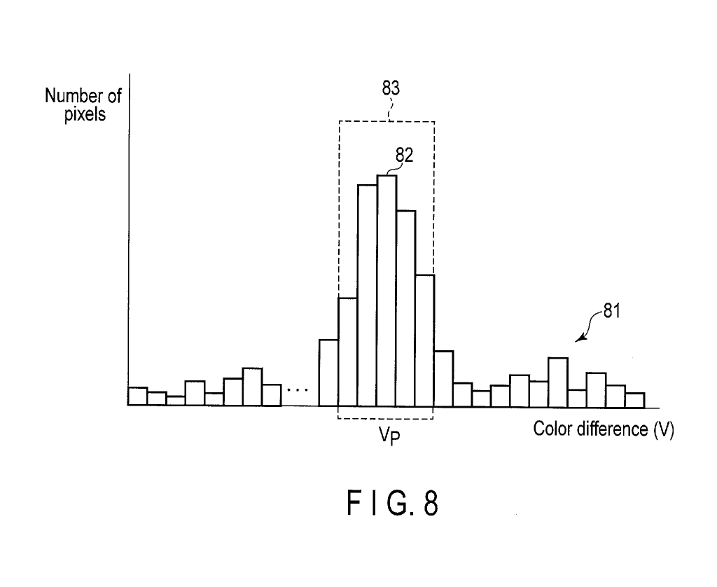

FIG. 8 shows histogram 81 calculated using a plurality of color differences V corresponding to a plurality of pixels included in the image 51. Color difference VP 82 having a maximum number of pixels is detected from the histogram 81. Then, color difference 83 within a predetermined range including the color difference VP 82 is determined, and the third pixel group, which corresponds to the color difference 83 within the predetermined range, in the image 51 is detected.

Next, the histogram peak common area detector 35 detects the second area 54 other than the first area from the image 51 in which the object including the first area corresponding to the writing 52 and 53 by the user is shot by detecting a pixel shared by the first to third pixel groups. That is, the pixel shared by the first to third pixel groups is used as the second area 54. The pixel shared by the first to third pixel groups is also hereinafter referred to as the pixel in the second area 54.

Further, the board type determination module 36 determines a type of object (board) included in the image 51. The board type determination module 36 determines which of the blackboard and whiteboard corresponds to an object included in the image 51 based on, for example, the average luminance or a bias of the histogram of the image 51.

Then, the histogram peak common area luminance value converter 37 changes the luminance of the pixel in the second area 54 detected by the histogram peak common area detector 35 to the luminance in accordance with the determined type of object (such that the luminance of the pixel in the second area 54 is made closer to the original luminance of the object). If the object is the blackboard, the histogram peak common area luminance value converter 37 changes the luminance Y of the pixel in the second area 54 to, for example, the luminance lower than the luminance Y (for example, in the case of the luminance of 256 gradation, 10). Further, if the object is the blackboard, the histogram peak common area luminance value converter 37 may multiply the luminance Y of the pixel in the second area 54 by a predetermined value (for example, 0.5) to lower the luminance Y.

Thus, for example, the luminance in the area (second area 54) of the blackboard itself appearing to have the luminance higher than the original luminance of the blackboard (for example, whitish) because of erasures of chalk having the luminance higher than that of the blackboard or a shooting environment can be darkened, allowing an image (output signal) 55 in which characters, figures, pictures, or the like are written on the blackboard to be clearly seen.

Further, if the object is the whiteboard, the histogram peak common area luminance value converter 37 changes the luminance Y of the pixel in the second area 54 to, for example, the luminance higher than the luminance Y (for example, in the case of the luminance of 256 gradation, 255).

Thus, for example, the luminance in the area (second area 54) of the whiteboard itself appearing to have the luminance lower than the original luminance of the whiteboard (for example, gray) because of erasures of the pen having the luminance lower than that of the whiteboard or a shooting environment can be brightened, allowing the image (output signal) 55 in which characters, figures, pictures, or the like are written on the whiteboard to be clearly seen.

Although the image 51 is represented by the luminance Y, color difference U and color difference V in the above description, the image 51 may be represented by RGB. In that case, the second area 54 other than the first area corresponding to the writing 52 and 53 by the user is detected using the histogram of each RGB, and the value of each RGB of the pixel included in the second area 54 is changed to be made closer to the original luminance of the object. This can reduce the difficulty in viewing due to the erasures on the image 51 as well as in the case where the image 51 is represented by the luminance Y, color difference U and color difference V.

Further, the second area 54 may be detected using only the histogram of the luminance Y of the image 51. This allows the processing for reducing the difficulty in viewing due to the erasures on the image 51 to be easily executed.

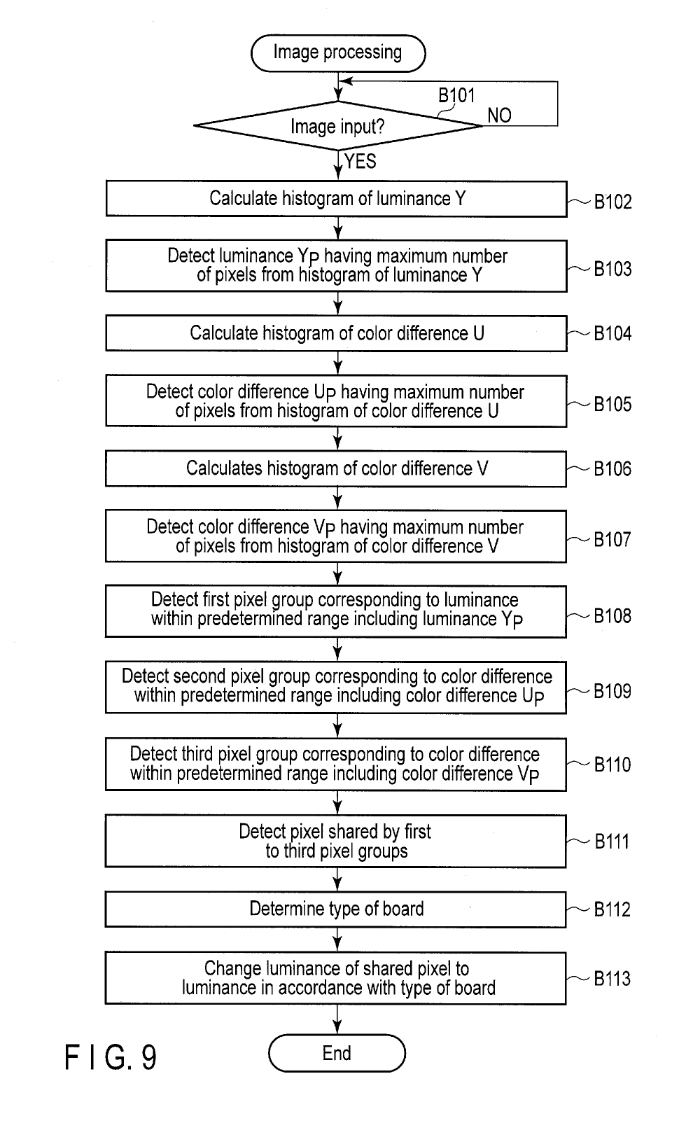

Next, an example of procedures of the image processing executed by the tablet computer 10 will be described with reference to the flowchart of FIG. 9.

First, the luminance signal histogram calculation module 31 and the color-difference signal histogram calculation module 33 determine whether the image (input signal) 51 to be processed is input (block B101). The image 51 is an image in which an object including the first area corresponding to the writing 52 and 53 by the user is shot. Further, the object is, for example, the blackboard or whiteboard.

If the image 51 to be processed is not input (NO in block B101), the processing returns to block B101, and whether the image 51 to be processed is input is determined again.

On the other hand, if the image 51 to be processed is input (YES in block B101), the luminance signal histogram calculation module 31 calculates the histogram 61 of luminance Y using a plurality of luminances Y corresponding to a plurality of pixels included in the image 51 (block B102). Then, the luminance signal histogram peak detector 32 detects the luminance YP having a maximum number (frequency) of pixels from the histogram 61 of luminance Y (block B103).

Further, the color-difference signal histogram calculation module 33 calculates the histogram 71 of color difference U using a plurality of color differences U corresponding to a plurality of pixels included in the image 51 (block B104). Then, the color-difference signal histogram peak detector 34 detects the color difference UP having a maximum number of pixels from the histogram 71 of color difference U (block B105).

Furthermore, the color-difference signal histogram calculation module 33 calculates the histogram 81 of color difference V using a plurality of color differences V corresponding to a plurality of pixels included in the image 51 (block B106). Then, the color-difference signal histogram peak detector 34 detects the color difference VP having a maximum number of pixels from the histogram 81 of color difference V (block B107).

Next, the histogram peak common area detector 35 detects the first pixel group corresponding to the luminance 63 within a predetermined range including the luminance YP (for example, luminance from YP−10 to YP+10) from the image 51 (block B108). The histogram peak common area detector 35 detects the second pixel group corresponding to the luminance 73 within a predetermined range including the color difference UP (for example, luminance from UP−10 to UP+10) from the image 51 (block B109). The histogram peak common area detector 35 detects the third pixel group corresponding to the luminance 83 within a predetermined range including the color difference VP (for example, luminance from VP−10 to VP+10) from the image 51 (block B110). Then, the histogram peak common area detector 35 detects a pixel shared by the first to third pixel groups (block B111). That is, the histogram peak common area detector 35 detects the second area 54 other than the first area from the image 51 in which the object including the first area corresponding to the writing 52 and 53 by the user is shot.

Further, the board type determination module 36 determines the type of board (object) included in the image 51 (block B112). For example, the board type determination module 36 determines which of the blackboard and whiteboard corresponds to the object included in the image 51.

Then, the histogram peak common area luminance value converter 37 changes the luminance of the shared pixel or pixels detected by the histogram peak common area detector 35 (second area 54) to the luminance in accordance with the determined type of board (block B113). If the object is the blackboard, the histogram peak common area luminance value converter 37 changes the luminance Y of the pixel or pixels in the second area 54 to, for example, the luminance lower than the luminance Y. Further, if the object is the whiteboard, the histogram peak common area luminance value converter 37 changes the luminance Y of the pixel or pixels in the second area 54 to, for example, the luminance higher than the luminance Y.

As described above, the present embodiment allows the difficulty in viewing due to the erasures to be reduced from the image in which the object including the erasures is shot. The histogram peak common area detector 35 detects the second area 54 other than the first area from the image 51 in which the object including the first area corresponding to the writing 52 and 53 by the user is shot. The histogram peak common area luminance value converter 37 corrects the luminance of the second area 54. The second area 54 includes the erasures generated by erasing the writing by the user. Thus, the difficulty in viewing due to the erasures can be reduced by changing the luminance of the second area 54 to the original luminance of the object.

All procedures of the image processing in the present embodiment can be executed by software. Thus, an advantage similar to that of the present embodiment can be easily achieved merely by installing a program for executing the procedures of the image processing in a normal computer through a computer-readable storage medium storing the program, and executing it.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic apparatus comprising:
a detector configured to receive an image of an object, the image comprising a first part and a second part, the first part comprising writing by a user, the second part not comprising the writing, and detect the second part of the image; and
a correction module configured to correct luminance of the second part of the image.

2. The electronic apparatus of claim 1, wherein
the second part comprises erasure generated by erasing the writing by a user.

3. The electronic apparatus of claim 1, wherein
the object comprises a blackboard.

4. The electronic apparatus of claim 1, wherein
the object comprises a whiteboard.

5. The electronic apparatus of claim 1, wherein
the object comprises either a blackboard or a whiteboard, and
the correction module is configured to correct the luminance of the second part based on which of the blackboard and whiteboard is the object.

6. The electronic apparatus of claim 1, wherein the detector is configured to detect the second part based on luminance corresponding to pixels of the image.

7. The electronic apparatus of claim 1, wherein
the detector is configured to detect the second part based on luminance corresponding to pixels of the image and color differences corresponding to the pixels.

8. A method comprising:
receiving an image of an object, the image comprising a first part and a second part, the first part comprising writing by a user, the second part not comprising the writing;
detecting the second part of the image; and
correcting luminance of the second part of the image.

9. The method of claim 8, wherein
the second part comprises erasure generated by erasing the writing by a user.

10. The method of claim 8, wherein
the object comprises one of a blackboard and a whiteboard.

11. The method of claim 8, wherein
the object comprises one of a blackboard and a whiteboard, and
the correcting comprising correcting the luminance of the second part based on which of the blackboard and whiteboard is the object.

12. The method of claim 8, wherein
the detecting comprises detecting the second part based on luminance corresponding to pixels of the image.

13. The method of claim 8, wherein
the detecting comprises detecting the second part based on luminance corresponding to pixels of the image and color differences corresponding to the pixels.

14. A non-transitory computer readable storage storing a computer program which is executable by a computer, the computer program comprising instructions capable of causing the computer to execute functions of:
receiving an image of an object, the image comprising a first part and a second part, the first part comprising writing by a user, the second part not comprising the writing;
detecting the second part of the image; and
correcting luminance of the second part of the image.

15. The storage medium of claim 14, wherein
the second part comprises erasure generated by erasing the writing by a user.

16. The storage medium of claim 14, wherein
the object comprises one of a blackboard and a whiteboard.

17. The storage medium of claim 14, wherein
the object comprises either a blackboard or a whiteboard, and
the correcting comprising correcting the luminance of the second part based on which of the blackboard and whiteboard is the object.

18. The storage medium of claim 14, wherein
the detecting comprises detecting the second part based on luminance corresponding to pixels of the image.

19. The storage medium of claim 14, wherein
the detecting comprises detecting the second part based on luminance corresponding to pixels of the image and color differences corresponding to the pixels.
